(19) United States
(12) Patent Application Publication
(10) Pub. No.: US 2009/0224608 A1
(43) Pub. Date: Sep. 10, 2009

(54) Ferrite Antennas for Wireless Power Transfer

(75) Inventors: Nigel P. Cook, El Cajon, CA (US); Peter Schwaninger, Solothurn (CH); Hanspeter Widmer, Solothurn (CH)

Correspondence Address: Law Office of Scott C Harris Inc, PO Box 1389, Rancho Santa Fe, CA, 92067, US

(73) Assignee: NIGEL POWER, LLC, San Diego, CA (US)

(21) Appl. No.: 12/391,054

(22) Filed: Feb. 23, 2009

Related U.S. Application Data
(60) Provisional application No. 61/030,987, filed on Feb. 24, 2008.

(51) Int. Cl. H02J 17/00

(52) U.S. Cl. 307/104

(57) ABSTRACT

A wirelessly-powered device that uses a ferrite based antenna. The ferrite antenna can be tuned to reduce the amount of flux within the housing.

This application claims priority from provisional application No. 61/030,987, filed Feb. 24, 2008, the entire contents of which disclosure is herewith incorporated by reference.

### BACKGROUND

Our previous applications and provisional applications, including, but not limited to, U.S. patent application Ser. No. 12/018,069, filed Jan. 22, 2008, entitled “Wireless Apparatus and Methods”, the disclosure of which is herewith incorporated by reference, describe wireless transfer of power. The transmit and receiving antennas are preferably resonant antennas, which are substantially resonant, e.g., within 10% of resonance, 15% of resonance, or 20% of resonance. The antenna is preferably of a small size to allow it to fit into a mobile, handheld device where the available space for the antenna may be limited. An embodiment describes a high efficiency antenna for the specific characteristics and environment for the power being transmitted and received. Antenna theory suggests that a highly efficient but small antenna will typically have a narrow band of frequencies over which it will be efficient. The special antenna described herein may be particularly useful for this kind of power transfer.

One embodiment uses an efficient power transfer between two antennas by storing energy in the near field of the transmitting antenna, rather than sending the energy into free space in the form of a travelling electromagnetic wave. This embodiment increases the quality factor (Q) of the antennas. This can reduce radiation resistance <Rᵣ) and loss resistance

In one embodiment, two high-Q antennas are placed such that they react similarly to a loosely coupled transformer, with one antenna inducing power into the other.

The antennas preferably have Qs that are greater than 200, although the receive antenna may have a lower Q caused by integration and damping.

### SUMMARY

The present application describes antennas for wireless power transfer.

### BRIEF DESCRIPTION OF THE DRAWINGS

In the Drawings:

FIG. 1 shows a block diagram with equivalent circuits;

FIG. 2 shows a measurement set up;

FIG. 3 shows a first ferrite rod antenna with partial coils;

FIG. 4 shows a second ferrite rod with a complete coil;

FIG. 5 shows a plot of resonance frequency; and

FIG. 6 shows a block diagram of the rod antenna in use.

### DETAILED DESCRIPTION

An embodiment uses ferrites in antennas for transmission and reception of magnetic flux used as wireless power. For example, ferrite materials usually include ceramics formed of MO—Fe₂O₃, where MO is a combination of divalent metals such as zinc, nickel, manganese and copper oxides. Common ferrites may include MnZn, NiZn and other Ni based ferrites.

Ferrite structures concentrate magnetic flux lines into the structure, thereby creating a magnetic path/field with less interference and eddy current losses in device electronics. This in essence sucks in the magnetic flux lines, thereby improving the efficiency of the magnetic power distribution. An embodiment describes a ferrite rod-shaped antennas. These may provide compact solutions that are easy to integrate into certain kinds of packaging. Also, the properties of ferrites may

The resonance frequency of Ferrite rod antennas may be easier to tune. In one embodiment, the tuning may be carried out by mechanically adjusting the position of the coil on the rod.

However, Ferrite rod antennas may suffer from Q degradation at higher magnetic field strengths (higher receive power levels) due to increasing hysteresis losses in Ferrite material. The present application describes use of special ferrite antennas to carry out wireless transfer of power.

The inventors realized that hysteresis losses in ferrite material may occur at higher power receive levels and higher magnetic field strengths. In addition, increasing the magnetic field strength may actually shift the resonance frequency, especially in certain materials where there are nonlinear B-H characteristics in the ferrites. In addition, harmonics emissions can be generated to in due to inherent nonlinearity. This nonlinearity becomes more important at lower Q factors.

One aspect of the present system is to compare the performance of these antennas, at different power levels and other different characteristics. By doing this, information about the way these materials operate in different characteristics is analyzed.

Ferrite Rod materials are normally used in communication receiver applications at small signal levels such as at or below 1 mW. No one has suggested using these materials at large levels, e.g. up to 2 W. In order to analyze the characteristics of these materials, measurement values and techniques are described herein. According to one embodiment, the measurement may be carried out at by using the antennas that transmit antenna, and assuming reciprocity as a receiving antenna. The tests increase the V and current, and determine the values of the result.

According to one embodiment, the Q value is used to determine a limit for the amount of power applied.

According to one embodiment, the characteristics of a ferrite Rod antenna are evaluated based on the following parameters
Q-factor
Resonance frequency
Voltage across antenna coil
Antenna current
Inductance of antenna coil
Equivalent permeability of rod
Equivalent series resistance
Magnetic inductance in Ferrite rod
Measurement of tuning range that can be achieved by mechanically tuning of a ferrite rod

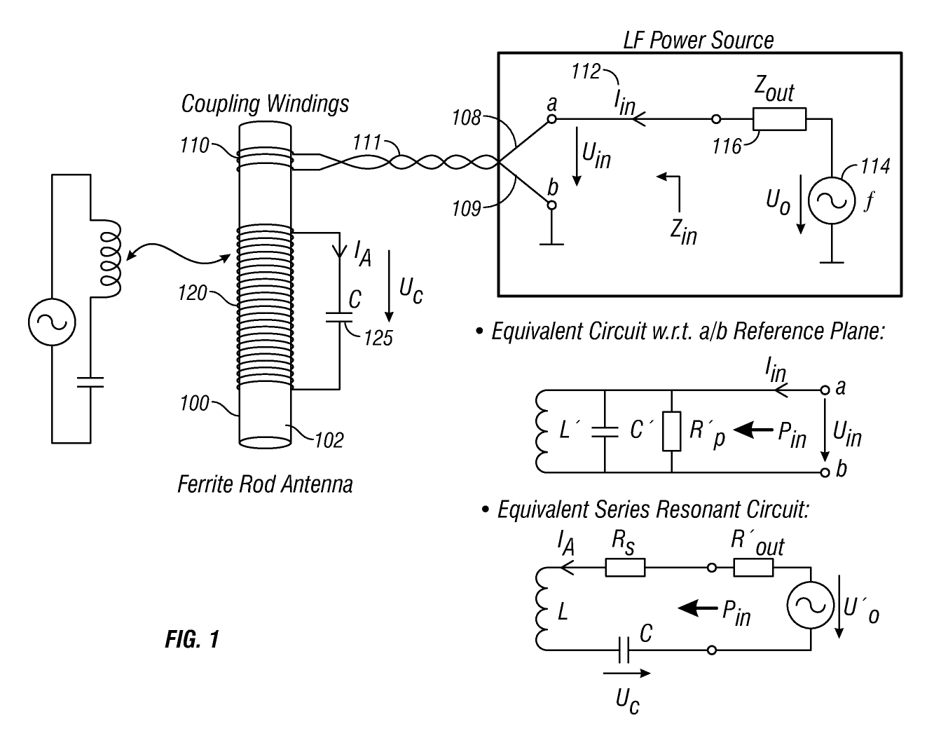

FIG. 1 illustrates the ferrite Rod antenna 100 under test, where the system is formed of a ferrite Rod 102, on which is wound two different sets of windings. The coupling windings 110 are connected to the electronic circuitry 112. In this embodiment, the electronic circuitry may be transmitting circuitry, however it should be understood that the electronic circuitry can alternately be receiving circuitry. Accordingly, the circuitry 112 is referred to herein as power converting circuitry. The power circuitry 112 is formed of an AC part, for example and AC generator, with a matching impedance 116. The matching impedance 116 is connected to a first wire 108 of the twisted-pair 111. The second wire 109 of the twisted-pair 111 goes to ground. The two wires 108, 109 are collectively connected to a coupling windings 120. Coupling winding 110 is located at a 1st place on the ferrite Rod 100 to. The coupling winding 110 is completely separated from the main winding 120. Moreover, the number of windings of the coupling winding 110 may be ⅕ to 1/10 the number of windings of 120. The important part is to induce magnetic flux into the ferrite Rod, without having the impedance of the inducement changed by any external characteristics.

The main winding 120 is also in parallel with a main capacitor 125.

A number of different values within the FIG. 1 embodiment may be measured. For example, these values may include

| | | |
|---|---|---|
| U₀: | Source voltage (e.m.f.) of LF power source | [V] |
| Zₒᵤₜ: | Output (source) impedance of LF power source | [Ω] |
| Uᵢₙ: | Input voltage measured at antenna terminals a/b | [V] |
| Iᵢₙ: | Input current measured at antenna terminals a/b | [A] |
| Zᵢₙ: | Input impedance measured at antenna terminals a/b | [Ω] |
| I_{A}: | Antenna current (r.m.s.) | [A] |
| U_{c}: | Voltage across antenna capacitance (r.m.s.) | [V] |
| Pᵢₙ: | Antenna input power | [W] |
| L: | Equivalent inductance of Ferrite rod antenna | [H] |
| | (includes all reactive components except C) | |
| C: | Capacitance required to achieve resonance frequency | [F] |
| Rₛ: | Equivalent series resistance of Ferrite rod antenna | [Ω] |
| | (includes all losses except source resistance) | |
| U₀′: | Source voltage transformed into equivalent series circuit | [V] |
| Rₒᵤₜ′: | Source resistance transformed into equivalent series circuit | [Ω] |
| Q_{UL}: | Unloaded Q-factor | |
| μ_{rod}: | Effective relative permeability of Ferrite rod | |
| B_{rod}: | Computed magnetic flux density (induction) in Ferrite rod | [T] |
| N: | Number of turns | |
| A_{Fe}: | Ferrite cross sectional area | [m²] |

The different characteristics can also be determined from these values, as

2.2.2.2 Equations

Resonance Frequency:

$${f}_{res} = \frac{1}{2 π \sqrt{L \cdot C}} \qquad Equation 2 \text{-} 1$$

Unloaded Q-Factor:

$${Q}_{UL} = \frac{1}{{R}_{s}} \sqrt{\frac{L}{C}} = \frac{2 π f L}{{R}_{s}} \\ {Q}_{UL} = \frac{2 π \cdot f \cdot C \cdot {U}_{c}^{2}}{{P}_{i n}} \qquad Equation 2 \text{-} 2$$

Input Power:

follows

Pᵢₙ=Re{Uᵢₙ·Iᵢₙ} Equation 2-3

Effective Relative Permeability of Ferrite Rod

$${μ}_{rod} = \frac{L}{{L}_{air}} \qquad Equation 2 \text{-} 4$$

Magnetic Flux Density (Inductance) in Ferrite Rod:

$${B}_{rod} = \frac{{U}_{C}}{π \cdot \sqrt{2} \cdot N \cdot {A}_{Fe} \cdot f} \qquad Equation 2 \text{-} 5$$

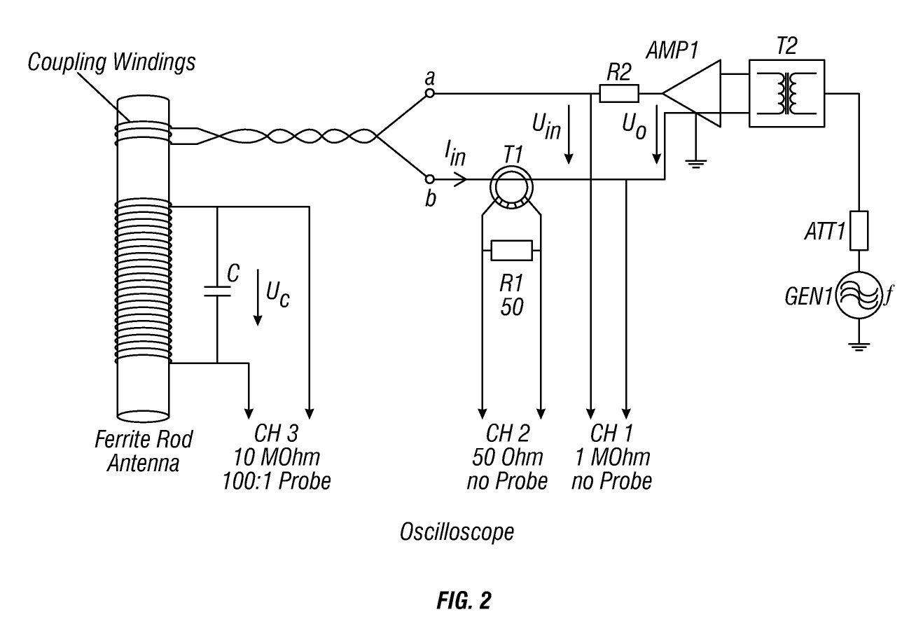

FIG. 2 illustrates the ways of measuring the different values, shown as channel 1, channel 2 and Channel 3. These different values can be measured as follows
Oscilloscope: measures r.m.s. of Uᵢₙ (CH1), Iᵢₙ (CH2), U_{C} (CH3)
T1: Current transformer, toroid Epcos R16/T38, 25 turns
R1: Load resistor of T1(R1//R(CH2)=25 . . . 100 Ohm, 25 Ohm: 1 A current→1V at CH2)
AMP1: Amplifier arcus 100 W, voltage gain=33 (135 kHz)
R2: Load resistor of AMP1, 5 . . . 50 Ohm (needed for safety and stability of the amplifier)
T2: Isolation transformer 1:1 (2*40 turns bifilar, Epcos R16/T38 toroid) to prevent from ground loop interference
ATT1: Attenuator 50 Ohm, 10 . . . 20 dB to prevent from overload of AMP1
GEN1: RF signal generator (Rohde&Schwarz SMG)

According to a measurement procedure, the generator is started with −10 DBM of power, and at a frequency that is resonant to the calculated resonant frequency from the equation 2.1. At this resonant frequency, all of the signals Uᵢₙ, Iᵢₙ and U_{c} are in phase so long as the polarities of channel 1 and Channel I mean channel 2 and Channel 3 is correct and the current channel (Ch2) has a minimum value.

The values of Uᵢₙ, Iᵢₙ and U_{c} are measured at the resonant frequency.

The remaining values are calculated.

Table 1 represents the results for an “X” antenna made using ferrite materials. The measured values are used to calculate certain other values within this antenna.

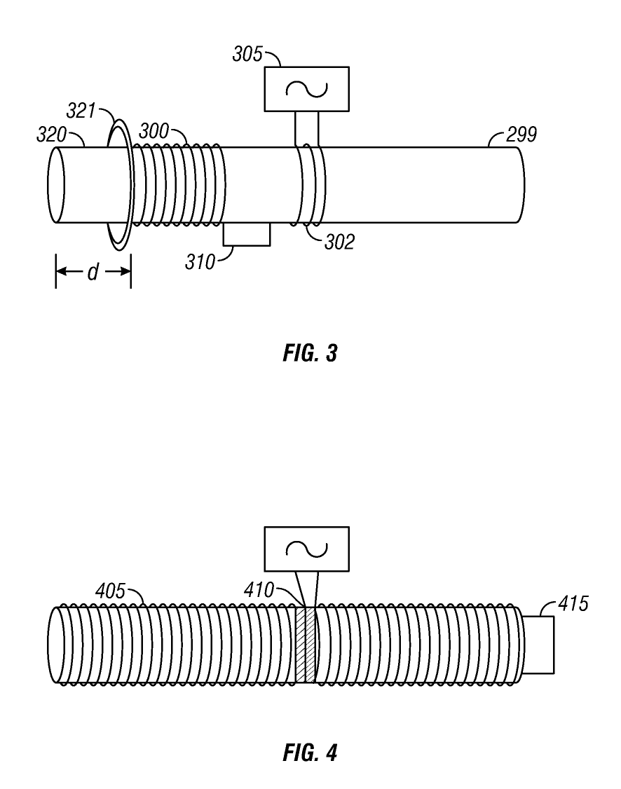

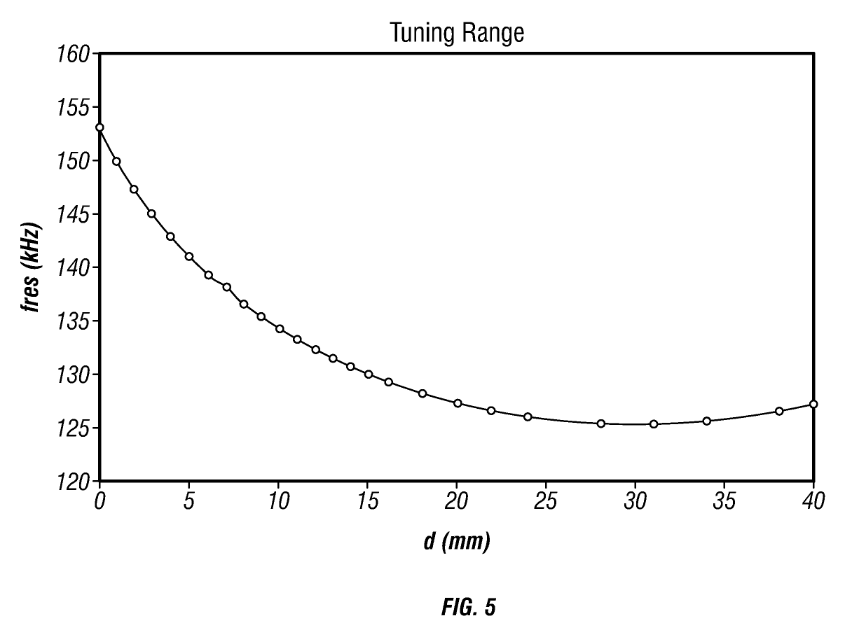

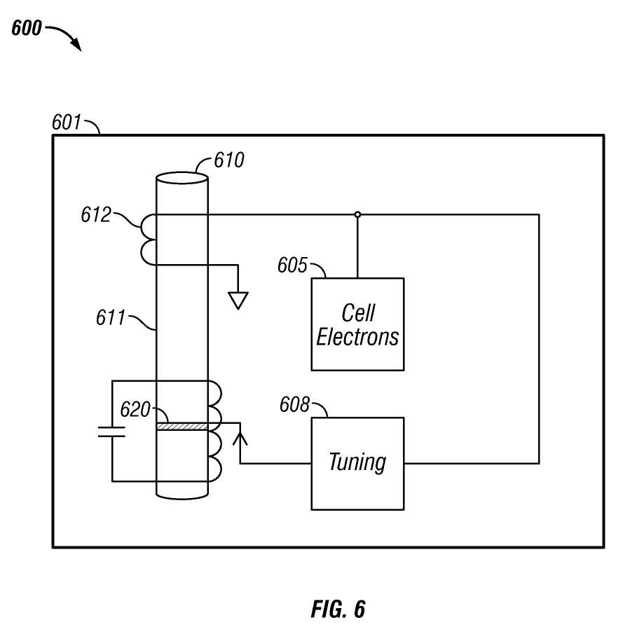

This antenna shown in FIG. 3 has a length of 87 mm, and a diameter of 10 mm. The ferrite material used is Ferroxcube 4B2. The main coil of this antenna has 19 windings of main coil 300 for a total length of 20 mm of 300×0.4 mm wire. A three turn coupling coil 302 is connected to receive the magnetic resonant field from a generator 305. The coupling coil 302 is spaced along the rod at 12 mm from the end of the main coil. A 55.17 nF 500V Mica capacitor 310 is used to form resonance. Q values are

A number of measurements were carried out as shown in Table 1, where the left side of the table represents the inputs to the coil. Based on these inputs, and the equations noted above, the values on the right side of the table were calculated.

TABLE I

| | Input (measured) | | | | Calculation | | |
|---|---|---|---|---|---|---|---|
| Meas | f res | U in | I in | Uc | P in | Z in | L |
| # | kHz | V rms | mA rms | V rms | mW | Ohm | μH |
| 8 | 134.98 | 0.00818 | 0.1406 | 0.0888 | 0.0012 | 58.179 | 25.200 |
| 7 | 134.97 | 0.0259 | 0.511 | 0.284 | 0.0132 | 50.685 | 25.204 |
| 6 | 134.9 | 0.0784 | 1.67 | 0.861 | 0.131 | 46.946 | 25.230 |
| 1 | 134.920 | 0.075 | 1.450 | 0.733 | 0.109 | 51.724 | 25.222 |
| 2 | 134.752 | 0.228 | 5.270 | 2.260 | 1.202 | 43.264 | 25.285 |
| 3 | 134.294 | 0.643 | 18.440 | 6.370 | 11.857 | 34.870 | 25.458 |
| 4 | 133.113 | 1.555 | 68.070 | 17.140 | 105.849 | 22.844 | 25.912 |
| 5 | 131.011 | 3.450 | 244.400 | 37.050 | 843.180 | 14.116 | 26.750 |

| | Calculation | | | | | | |
|---|---|---|---|---|---|---|---|
| Meas | X | Q UL | I A | R s | μ rod | B rod | R p |
| # | Ohm | U | mA rms | Ohm | U | mT peak | Ohm |
| 8 | 21.372 | 320.804 | 4.155 | 0.0666 | 12.632 | 0.099 | 6856.3 |
| 7 | 21.374 | 285.126 | 13.287 | 0.0750 | 12.633 | 0.318 | 6094.2 |
| 6 | 21.385 | 264.770 | 40.262 | 0.0808 | 12.647 | 0.963 | 5662.1 |
| 1 | 21.382 | 231.067 | 34.282 | 0.0925 | 12.643 | 0.820 | 4940.6 |
| 2 | 21.408 | 198.559 | 105.567 | 0.1078 | 12.674 | 2.531 | 4250.8 |
| 3 | 21.481 | 159.311 | 296.537 | 0.1348 | 12.761 | 7.159 | 3422.2 |
| 4 | 21.672 | 128.067 | 790.886 | 0.1692 | 12.988 | 19.434 | 2775.5 |
| 5 | 22.020 | 73.934 | 1682.592 | 0.2978 | 13.408 | 42.683 | 1628.0 |

The table shows that the Q value stays greater than 100 up to a power level of approximately 100 mw. The 840 mw measurement showed a Q of 73, and a resonant frequency that has shifted by almost 4 Khz from the value it shows at 10⁻³ mw. Note again, as discussed

According to one embodiment, therefore, the antenna is only operated in regions where it has specific values that are within the desired values of operation of the antenna, e.g, high enough Q, proper frequency, etc.

A second embodiment used an antenna as shown in FIG. 4. This used a similar sized rod formed of similar material. Antenna 400 uses 75 turns of wire 405 and a two-turn coupling coil 410, located over the main coil, at 25 mm from the end of the main coil. This antenna uses a 6.878 nF 400 V polypropylene capacitor 415.

Table 2 represents second measured and calculated results for the FIG. 4 antenna.

| | Input (measured) | | | | Calculation | | | | | | | | | |
|---|---|---|---|---|---|---|---|---|---|---|---|---|---|---|
| Meas | f res | U in | I in | Uc | P in | Z in | L | X | Q UL | I A | R s | μ rod | B rod | R p |
| # | kHz | V rms | mA rms | V rms | mW | Ohm | μH | Ohm | U | mA rms | Ohm | U | mT peak | Ohm |
| 1 | 133.601 | 0.0274 | 0.38 | 0.895 | 0.0104 | 72.105 | 206.328 | 173.200 | 444.185 | 5.187 | 0.3889 | 23.235 | 0.258 | 76932.9 |
| 2 | 133.541 | 0.0828 | 1.265 | 2.684 | 0.1047 | 65.455 | 206.514 | 173.278 | 396.918 | 15.490 | 0.4366 | 23.256 | 0.768 | 68777.1 |
| 3 | 133.333 | 0.2336 | 4.462 | 7.68 | 1.042 | 52.353 | 207.159 | 173.548 | 326.062 | 44.253 | 0.5323 | 23.329 | 2.201 | 58587.4 |
| 4 | 132.763 | 0.610 | 17.240 | 19.710 | 10.518 | 35.389 | 208.941 | 174.293 | 211.911 | 113.085 | 0.8225 | 23.529 | 5.673 | 36934.7 |
| 5 | 131.504 | 1.404 | 65.100 | 45.860 | 91.400 | 21.567 | 212.961 | 175.962 | 130.768 | 260.624 | 1.3456 | 23.982 | 13.325 | 23010.2 |
| 6 | 129.342 | 2.882 | 247.000 | 94.650 | 711.854 | 11.668 | 220.140 | 178.903 | 70.345 | 529.057 | 2.5432 | 24.791 | 27.962 | 12584.9 |
| 7 | 127.234 | 4.720 | 652.000 | 149.200 | 3077.440 | 7.239 | 227.495 | 181.867 | 39.773 | 820.378 | 4.5726 | 25.619 | 44.807 | 7233.5 |

What is claimed is:

1. A method, comprising:
integrating a ferrite element in an electronic device, said ferrite element including an inductive part wound thereon, as an antenna, said ferrite element including a first coil portion which is connected in series with a capacitor to form an LC resonant circuit value that is resonant with an applied magnetic driving signal, and also including a second coil portion wound thereon, electrically separated from the first coil portion; and
receiving power wirelessly using said ferrite element, at a frequency that is substantially resonant with a value determined according to said LC resonant circuit, and producing an output using said second coil portion to drive said electronic device.

2. A method as in claim 1, further comprising tuning the ferrite element based on characteristics of the reception.

3. A method as in claim 2, wherein said characteristics include an amount of power received by the phone.

4. A method as in claim 2, wherein said tuning comprises changing a Q value of said first coil portion on said ferrite element.

5. A method as in claim 2, wherein said tuning comprises changing a resonant frequency value of said first coil portion.

6. A method as in claim 2, wherein said tuning comprises changing a characteristic to absorb a maximum amount of magnetic flux within the casing.

7. A method as in claim 1, wherein said second coil part has more than ⅕ fewer windings than said first coil part.

8. A method as in claim 1, wherein said ferrite element is a ferrite Rod which is substantially cylindrical.

9. The portable device, comprising:
a housing;
a ferrite antenna, inside said housing, and having a first coil part thereon in parallel with a capacitor forming an LC value, a second coil part thereon, and where said first and second coil parts are electrically unconnected with one another;
a circuit, that receives power from said second coil part, and transfers said power to a powered device within said housing to power said device,
wherein said ferrite antenna operates to reduce an amount of magnetic flux within the housing.

10. The portable device as in claim 9, wherein said ferrite antenna is a ferrite rod, extending across an area of said housing.

12. A device as in claim 9, further comprising a tuning part for the first coil part, said tuning part changing at least one parameter of said first coil part according to an amount of received power.

13. A device as in claim 12, wherein said tuning part changes a resonant frequency of said first coil part.

14. A device as in claim 12, wherein said tuning part changes a Q value of said first coil part.

15. A device as in claim 12, wherein said tuning part is controlled according to a parameter of operation of said powered device, to automatically change said tuning.

16. A Device as in claim 12, wherein said tuning part is controlled by an amount which minimizes a magnetic flux within the housing.
